(19) United States
(12) Patent Application Publication
(10) Pub. No.: US 2023/0373749 A1
(43) Pub. Date: Nov. 23, 2023

(54) ELEVATOR COMMUNICATION SYSTEM, AND A METHOD AND AN APPARATUS IN AN ELEVATOR SYSTEM

(71) Applicant: KONE CORPORATION, Helsinki (FI)

(72) Inventors: Ari KATTAINEN, Helsinki (FI); Naganna VYDYULA, Helsinki (FI)

(73) Assignee: KONE CORPORATION, Helsinki (FI)

(21) Appl. No.: 18/228,248

(22) Filed: Jul. 31, 2023

Related U.S. Application Data
(63) Continuation of application No. PCT/EP2021/052328, filed on Feb. 1, 2021.

(51) Int. Cl. B66B 1/34; B66B 5/00; B66B 3/00; B66B 1/24

(52) U.S. Cl. CPC B66B 1/3461; B66B 1/3423; B66B 5/0006; B66B 3/008; B66B 1/2408

(57) ABSTRACT

According to an aspect, there is provided an elevator communication system. The system comprises an elevator communication network configured to carry elevator system associated data and a plurality of elevator system nodes communicatively connected to the elevator communication network, wherein at least some of the plurality of elevator system nodes each comprises a camera associated with different landing floors, respectively, configured to provide image data about a respective landing floor area and wherein at least one of the plurality of elevator system nodes comprises a display arranged in an elevator car; and an apparatus communicatively connected to the elevator communication network, the apparatus being configured to receive an elevator call to a landing floor, and cause the display to display data provided by a camera associated with the landing floor in response to the elevator call to the landing floor.

### TECHNICAL FIELD

The present application relates to the field of elevator communication systems.

### BACKGROUND

In modern elevator system, elevators can be controlled efficiently to transport passenger between floors in a building. However, sometimes it may happen that a passenger has made an elevator call to a target floor in which a threatening situation may currently prevail. As the passenger is in an elevator car, he/she may not be able to receive any warning information about the situation in the target floor.

### SUMMARY

According to a first aspect, there is provided an elevator communication system comprising an elevator communication network configured to carry elevator system associated data and a plurality of elevator system nodes communicatively connected to the elevator communication network, wherein at least some of the plurality of elevator system nodes each comprises a camera associated with different landing floors, respectively, configured to provide image data about a respective landing floor area and wherein at least one of the plurality of elevator system nodes comprises a display arranged in an elevator car. The elevator communication system further comprises an apparatus communicatively connected to the elevator communication network, the apparatus being configured to receive an elevator call to a landing floor, and cause the display to display data provided by a camera associated with the landing floor in response to the elevator call to the landing floor.

In an implementation form of the first aspect, the camera is integrated into a respective landing floor display.

In an implementation form of the first aspect, the camera is integrated into an elevator call device arranged at the landing floor.

In an implementation form of the first aspect, the apparatus is configured to cause the display to display data provided by another camera associated with another landing floor in response to a subsequent elevator call to the another landing floor.

In an implementation form of the first aspect, the subsequent elevator call is a car call.

In an implementation form of the first aspect, the elevator communication network comprises at least one point-to-point ethernet network.

In an implementation form of the first aspect, the elevator communication network comprises at least one multi-drop ethernet segment.

In an implementation form of the first aspect, the display is arranged in a car operating panel.

In an implementation form of the first aspect, the car operating panel comprises a call revocation button configured to cause the elevator car to stop to the nearest possible floor in response to an action of the call revocation button.

According to a second aspect, there is provided a method comprising: receiving, by an apparatus, an elevator call to a landing floor, and controlling, by the apparatus, a display arranged at an elevator car allocated to serve the elevator call to display data provided by a camera associated with the landing floor, the apparatus, the display and the camera being communicatively connected to an elevator communication network.

In an implementation form of the second aspect, the camera is integrated into a respective landing floor display.

In an implementation form of the second aspect, the camera is integrated into an elevator call device arranged at the landing floor.

In an implementation form of the second aspect, the method further comprises causing, by the apparatus, the display to display data provided by another camera associated with another landing floor in response to a subsequent elevator call to the another landing floor.

In an implementation form of the second aspect, the subsequent elevator call is a car call.

In an implementation form of the second aspect, the elevator communication network comprises a point-to-point ethernet network.

In an implementation form of the second aspect, the elevator communication network comprises at least one multi-drop ethernet segment.

In an implementation form of the second aspect, the display is arranged in a car operating panel.

In an implementation form of the second aspect, the car operating panel comprises a call revocation button configured to cause the elevator car to stop to the nearest possible floor in response to an action of the call revocation button.

According to a third aspect, there is provided an apparatus comprising: means for receiving an elevator call to a landing floor; and means for controlling a display arranged at an elevator car allocated to serve the elevator call to display data provided by a camera associated with the landing floor, the apparatus, the display and the camera being communicatively connected to an elevator communication network.

In an implementation form of the third aspect, the apparatus comprises an elevator controller.

In an implementation form of the third aspect, the apparatus comprises a server communicatively connected to the elevator communication network.

According to a fourth aspect, there is provided an elevator system comprising an elevator communication system of the first aspect.

According to a fifth aspect, there is provided a computer program comprising program code, which when executed by at least one processor, causes the at least one processor to perform the method of the second aspect.

According to a sixth aspect, there is provided a computer readable medium comprising program code, which when executed by at least one processor, causes the at least one processor to perform the method of the second aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator communication system according to an example embodiment.

FIG. 1B illustrates an elevator communication system according to another example embodiment.

FIG. 2 illustrates an apparatus associated with an elevator communication system according to an embodiment.

FIG. 3 illustrates a method according to an example embodiment.

### DETAILED DESCRIPTION

The following description illustrates an elevator communication system that comprises an elevator communication network configured to carry elevator system associated data and a plurality of elevator system nodes communicatively connected to the elevator communication network, wherein at least some of the plurality of elevator system nodes each comprises a camera associated with different landing floors, respectively, configured to provide image data about a respective landing floor area and wherein at least one of the plurality of elevator system nodes comprises a display arranged in an elevator car. The elevator communication system further comprises an apparatus configured to receive an elevator call to a landing floor, and cause the display to display data provided by a camera associated with the landing floor in response to the elevator call to the landing floor. The illustrated solution may enable, for example, a solution in which a passenger is able to see image data from a target floor to which he/she is travelling, and after that make a decision whether it is, for example, safe to travel to the target floor.

In an example embodiment, the various embodiments discussed below may be used in an elevator system comprising an elevator that is suitable and may be used for transferring passengers between landing floors of a building in response to service requests. In another example embodiment, the various embodiments discussed below may be used in an elevator system comprising an elevator that is suitable and may be used for automated transferring of passengers between landings in response to service requests.

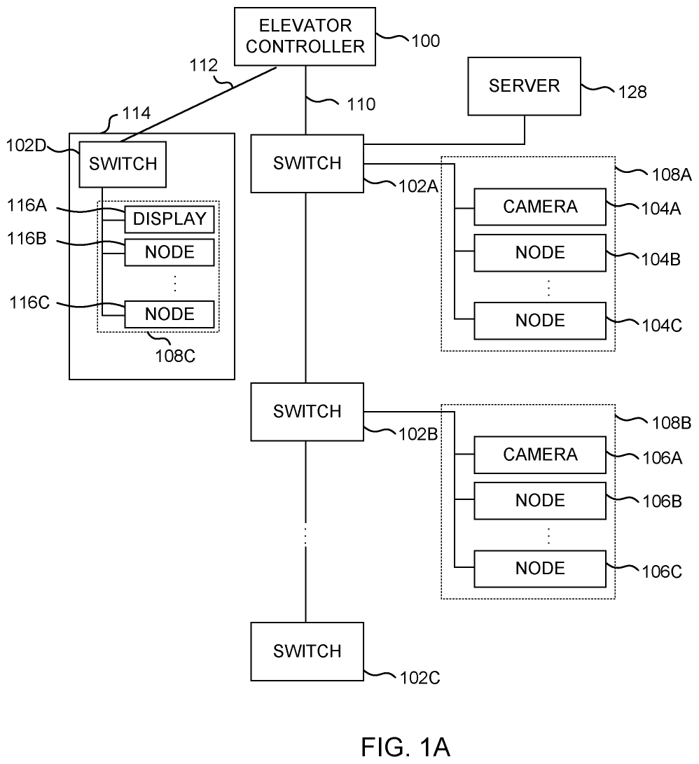

FIG. 1A illustrates an elevator communication system according to an example embodiment. The elevator communication system may comprise an elevator controller 100. The elevator communication system further comprises an elevator communication network configured to carry elevator system associated data. The elevator communication network may be an ethernet-based communication network and it may comprise at least one point-to-point ethernet bus 110, 112 and/or at least one multi-drop ethernet segment 108A, 108B, 108C. The point-to-point ethernet bus may be, for example, a 100BASE-TX or a 10BASET1L point-to-point ethernet bus. The multi-drop ethernet bus segments may comprise, for example, a 10BASE-T1S multi-drop ethernet bus.

In an example embodiment, the elevator communication system may comprise at least one connecting unit 102A, 102B, 102C comprising a first port connected to the respective multi-drop ethernet bus segments 108A, 108B and a second port connected to the point-to-point ethernet bus 110. Thus, by using the connecting units 102A, 102B, 102C, one or more multi-drop ethernet bus segments 108A, 108B may be connected to the point-to-point ethernet bus 110. The connecting unit 102A, 102B, 102C may refer, for example, to a switch.

In the embodiment illustrated in FIG. 1A, the elevator communication system comprises a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A, 116B, 116C may be connected. In an example embodiment, the elevator car nodes 116A, 116B, 116C may be connected to the connecting unit 102D via a multi-drop ethernet bus segment 108C, thus constituting an elevator car segment 108C. In an example embodiment, the point-to-point-ethernet bus 112 may be located in the travelling cable of the elevator car 114.

The elevator communication system may further comprise one or more multi-drop ethernet bus segments 108A, 108B (for example, in the form of 10BASE-T1S) reachable by the elevator controller 100, and a plurality of elevator system nodes 104A, 104B, 104C, 106A, 106B, 106C coupled to the multi-drop ethernet bus segments 108A, 108B and configured to communicate via the multi-drop ethernet bus 108A, 108B. The elevator controller 100 is reachable by the elevator system nodes 104A, 104B, 104C, 106A, 106B, 106C via the multi-drop ethernet bus segments 108A, 108B. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, an elevator system node 104A, 104B, 104C, 106A, 106B, 106C may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 104A, 104B, 104C, 106A, 106B, 106C may comprise shaft nodes, and a plurality of shaft nodes may form a shaft segment, for example, the multi-drop ethernet bus segment 108A, 108B.

At least some of the plurality of elevator system nodes 104A-104C, 106A-106C, 116A-116C each may comprise a camera 104A, 106A associated with different landing floors, respectively, configured to provide image data about a respective landing floor area. The image data may comprise still image data or video data. The camera 104A, 106A may be integrated into a respective landing floor display which is located, for example, above the landing doors. The camera 104A, 106A may also be integrated into an elevator call device arranged at the landing floor. The plurality of elevator system nodes 104A-104C, 106A-106C, 116A-116C may also comprise a display 116A arranged in the elevator car 114. The display 116A is configured to display data provided by the camera 104A, 106A associated with a landing floor in response to an elevator call to the landing floor. When the elevator controller 100 receives the elevator call to the landing floor, it allocates an elevator to serve the elevator call and controls the display 116A in the elevator to display data provided by the camera 104A, 106A in response to the elevator call. In another example embodiment, a separate network node, for example, a server 128 communicatively connected to the controller 100 may receive an indication of the elevator call from the controller 100 and cause the display 116A to display data provided by the camera 104A, 106A associated with the landing floor. This enables a solution in which an elevator passenger is able to see the landing floor surroundings before arriving at the landing floor. In other words, a passenger is, for example, able to see whether it is safe to travel to the target floor. Or, if the passenger is a fireman travelling to the target floor during a fire situation, the fireman is able to see the landing floor surroundings before arriving at the landing floor and is able to act in a correct way.

When the elevator car 114 is travelling to the landing floor in response to the elevator call, a subsequent elevator call for the elevator car 114 may be received. The subsequent elevator call may originate from the passenger in the elevator car 114, and the passenger may have initiated the subsequent elevator call after seeing from the display 116A that it is not safe to travel to the originally intended landing floor. The subsequent elevator call may be given, for example, using a car operating panel of the elevator car 114. In response to the subsequent elevator call, the display 116A may be configured to display data provided by a camera of a target floor associated with the subsequent elevator call. In other words, when a passenger changes the target floor by pressing another floor button of a car operating panel inside the elevator car 114, the view at the display 116A may change from a view provided by a camera associated with the original elevator call to a view provided by a camera associated with the subsequent elevator call.

In an embodiment, the car operating panel may comprise a call revocation button configured to cause the elevator car to stop to the nearest possible floor in response to an action of the call revocation button. In other words, when the passenger sees from the display 116A based on which the passenger does not want to travel to the intended target floor, the passenger may cancel the travel by pressing the call revocation button.

FIG. 1B illustrates an elevator communication system according to an example embodiment. The elevator communication system may comprise an elevator controller 100. The elevator communication system further comprises an elevator communication network configured to carry elevator system associated data. The elevator communication network may be an ethernet-based communication network and it may comprise at least one point-to-point ethernet bus and/or at least one multi-drop ethernet segment. The point-to-point ethernet bus may be, for example, a 100BASE-TX or 10BASET1L point-to-point ethernet bus. The multi-drop ethernet bus segments may comprise, for example, a 10BASE-T1S multi-drop ethernet bus.

In the embodiment illustrated in FIG. 1B, the elevator communication system comprises a point-to-point ethernet bus 112 that provides a connection to an elevator car 114 and to various elements associated with the elevator car 114. The elevator car 114 may comprise a connecting unit 102D, for example, a switch, to which one or more elevator car nodes 116A, 116B, 116C may be connected. In an example embodiment, the elevator car nodes 116A, 116B, 116C may be connected to the connecting unit 102D via a multi-drop ethernet bus segment 122C, thus constituting an elevator car segment 122C. In an example embodiment, the point-to-point-ethernet bus 112 is located in the travelling cable of the elevator car 114.

The elevator communication system may further comprise one or more multi-drop ethernet bus segments 122A, 122B (for example, in the form of 10BASE-T1S) reachable by the elevator controller 100, and a plurality of elevator system nodes 118A-118C, 120A-120C, 124A-124F coupled to the multi-drop ethernet bus segments 122A, 122B, 126A-126C and configured to communicate via the multi-drop ethernet bus segment 122A, 122B, 126A-126C. The elevator controller 100 is reachable by the elevator system nodes 118A-118C, 120A-120C, 124A-124F via the multi-drop ethernet bus segments 122A, 122B, 126A-126C. Elevator system nodes that are coupled to the same multi-drop ethernet bus segment may be configured so that one elevator system node is to be active at a time while the other elevator system nodes of the same multi-drop ethernet bus segment are in a high-impedance state.

In an example embodiment, the elevator communication system may comprise at least one connecting unit 102A, 102B, 102C comprising a first port connected to the respective multi-drop ethernet bus segments 122A, 122B and a second port connected to the point-to-point ethernet bus 110. Thus, by using the connecting units 102A, 102B, 102C, one or more multi-drop ethernet bus segments 122A, 122B may be connected to the point-to-point ethernet bus 110. The connecting unit 102A, 102B, 102C may refer, for example, to a switch.

In an example embodiment, an elevator system node 118A-118C, 120A-120C, 124A-124F may be configured to interface with at least one of an elevator fixture, an elevator sensor, an elevator safety device, audio means (for example, a microphone and/or a loudspeaker), a camera and an elevator control device. Further, in an example embodiment, power to the nodes may be provided with the same cabling. In another example embodiment, the elevator system nodes 118A-118C, 120A-120C, 124A-124F may comprise shaft nodes, and a plurality of shaft nodes may form a shaft segment, for example, the multi-drop ethernet bus segment 122A, 122B, 126A-126C.

The plurality of elevator system nodes 116A-116C, 118A-118C, 120A-120C, 124A-124F comprises a camera 124A, 124C, 124E each associated with respective landing floor configured to provide image data about a respective landing floor area. The camera 124A, 124C, 124E may be integrated into a respective landing floor display which is located, for example, above the landing doors. The camera 124A, 124C, 124E may also be integrated into an elevator call device arranged at the landing floor. The plurality of elevator system nodes 116A-116C, 118A-118C, 120A-120C, 124A-124F also comprise a display 116A arranged in the elevator car 114. The display 116A may be configured to display data provided by the camera 104A, 106A of a landing floor in response to an elevator call to the landing floor. When the elevator controller 100 receives the elevator call to the landing floor, it allocates an elevator to serve the elevator call and controls a display in the elevator to display data provided by the camera 124A, 124C, 124E in response to the elevator call. In another example embodiment, a separate network node, for example, a server 128 communicatively connected to the controller 100 may receive an indication of the elevator call from the controller 100 and cause the display 116A to display data provided by the camera 104A, 106A associated with the landing floor. This enables a solution in which an elevator passenger is able to see the landing floor surroundings before arriving at the landing floor. In other words, a passenger is, for example, able to see whether it is safe to travel to the target floor. Or, if the passenger is a fireman travelling to the target floor during a fire situation, the fireman is able to see the landing floor surroundings before arriving at the landing floor.

When the elevator car 114 is travelling to the landing floor in response to the elevator call, a subsequent elevator call for the elevator car 114 may be received. The subsequent elevator call may originate from the passenger in the elevator car 114, and the passenger may have initiated the subsequent elevator call after seeing from the display 116A that it is not safe to travel to the originally intended landing floor. The subsequent elevator call may be given, for example, using a car operating panel of the elevator car 114. In response to the subsequent elevator call, the display 116A may be configured to display data provided by a camera of a target floor associated with the subsequent elevator call. In other words, when a passenger changes the target floor by pressing another floor button of a car operating panel inside the elevator car 114, the view at the display 116A may change from a view provided by a camera associated with the original elevator call to a view provided by a camera associated with the subsequent elevator call.

In an embodiment, the car operating panel may comprise a call revocation button configured to cause the elevator car to stop to the nearest possible floor in response to an action of the call revocation button. In other words, when the passenger sees from the display 116A based on which the passenger does not want to travel to the intended target floor, the passenger may cancel the travel by pressing the call revocation button.

By implementing communication within the elevator communication system using at least one point-to-point ethernet bus and at least one multi-drop ethernet bus segment, various segments can be formed within the elevator communication system. For example, the elevator system nodes 124A, 124B may form a first landing segment, the elevator system nodes 124C, 124D may form a second landing segment, the elevator system nodes 124D, 124F may form a third landing segment, the shaft nodes 118A-118C may form a first shaft segment, the shaft nodes 120A-120C may form a second shaft segment, and the elevator car nodes 116A-116C may form an elevator car segment 122C. Each of the segments 122A-122C, 126A-126C may be implemented using separate multi-drop ethernet buses.

As illustrated in FIG. 1B, the shaft nodes 120A-120C interconnect the shaft segment 122B to which the shaft nodes 120A-120C are connected to and the landing segments 126A-126C. In other words, the shaft nodes 120A-120C may comprise or may act as a switch to the landing segments 126A-126C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc. may be connected.

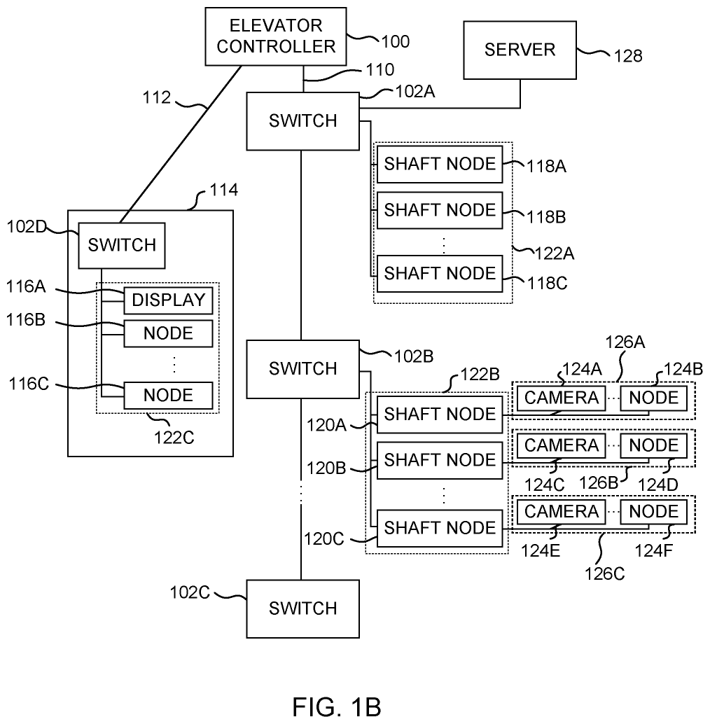

FIG. 2 illustrates an apparatus 200 associated with an elevator communication system according to an embodiment. The apparatus 200 may comprise at least one processor 202. The apparatus 200 may further comprise at least one memory 204. The memory 204 may comprise program code 206 which, when executed by the processor 202 causes the apparatus 200 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the apparatus 200 is illustrated as a single device it is appreciated that, wherever applicable, functions of the apparatus 200 may be distributed to a plurality of devices.

Example embodiments may be implemented in software, hardware, application logic or a combination of software, hardware and application logic. The example embodiments can store information relating to various methods described herein. This information can be stored in one or more memories 204, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 202 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 204 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 200 may comprise a communication interface 208 configured to enable the apparatus 200 to transmit and/or receive information, to/from other apparatuses.

The apparatus 200 comprises means for performing at least one method described herein. In one example, the means may comprise the at least one processor 202, the at least one memory 204 including program code 206 configured to, when executed by the at least one processor 202, cause the apparatus 200 to perform the method.

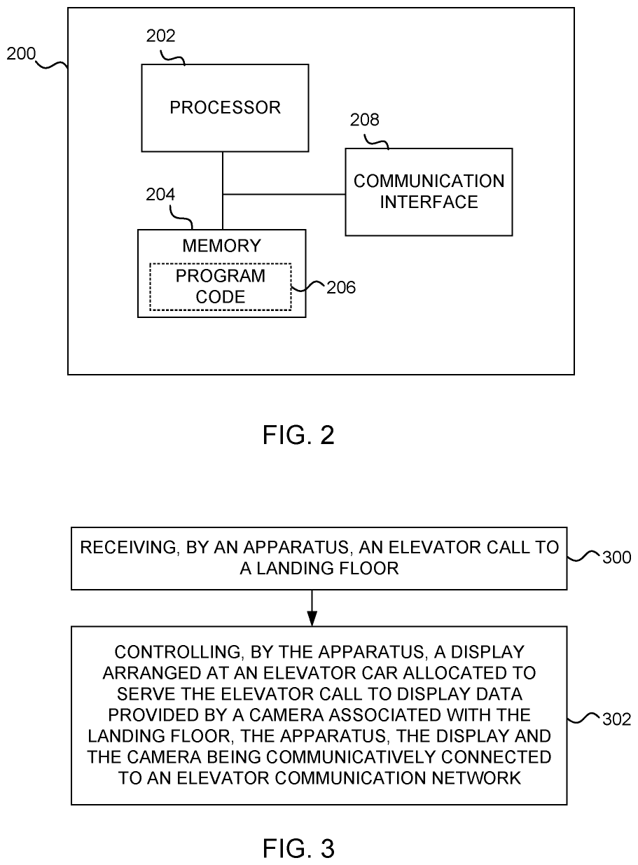

FIG. 3 illustrates a method according to an example embodiment.

At 300, an elevator call to a landing floor is received by an apparatus. The apparatus may be, for example, a controller, a server or an elevator controller being communicatively connected to an elevator communication network.

At 302 a display arranged at an elevator car allocated to serve the elevator call is controlled by the apparatus to display data provided by a camera associated with the landing floor, the display and the camera being communicatively connected to the elevator communication network.

At least some of the above discussed example embodiments may enable transmission of any device data seamlessly between elevator system devices and any other device or system. Further, a common protocol stack may be used for all communication. Further, at least some of the above discussed example embodiments may enable a solution in which a passenger is able to see image data from a target floor towards which he/she is travelling in the elevator car. If, based on the image data, the passenger decides not to travel to the target floor, he/she may make a new car call to another floor replacing the original elevator call. Further, when using an ethernet based communication architecture, image data may be recorded and sent further quickly and efficiently.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator communication system, comprising:
an elevator communication network configured to carry elevator system associated data;
a plurality of elevator system nodes communicatively connected to the elevator communication network, wherein at least some of the plurality of elevator system nodes each comprises a camera associated with different landing floors, respectively, configured to provide image data about a respective landing floor area and wherein at least one of the plurality of elevator system nodes comprises a display arranged in an elevator car; and
an apparatus communicatively connected to the elevator communication network, the apparatus being configured to:
receive an elevator call to a landing floor; and
cause the display to display data provided by a camera associated with the landing floor in response to the elevator call to the landing floor.

2. The elevator communication system of claim 1, wherein the camera is integrated into a respective landing floor display.

3. The elevator communication system of claim 1, wherein the camera is integrated into an elevator call device arranged at the landing floor.

4. The elevator communication system of claim 1, wherein the apparatus is configured to cause the display to display data provided by another camera associated with another landing floor in response to a subsequent elevator call to the another landing floor.

5. The elevator communication system of claim 4, wherein the subsequent elevator call is a car call.

6. The elevator communication system of claim 1, wherein the elevator communication network comprises at least one point-to-point ethernet network.

7. The elevator communication system of claim 1, wherein the elevator communication network comprises at least one multi-drop ethernet segment.

8. The elevator communication system of claim 1, wherein the display is arranged in a car operating panel.

9. The elevator communication system of claim 8, wherein the car operating panel comprises a call revocation button configured to cause the elevator car to stop to the nearest possible floor in response to an action of the call revocation button.

10. A method comprising:
receiving, by an apparatus, an elevator call to a landing floor; and
controlling, by the apparatus, a display arranged at an elevator car allocated to serve the elevator call to display data provided by a camera associated with the landing floor, the apparatus, the display and the camera being communicatively connected to an elevator communication network.

11. The method of claim 10, wherein the camera is integrated into a respective landing floor display.

12. The method of claim 10, wherein the camera is integrated into an elevator call device arranged at the landing floor.

13. The method of claim 10, further comprising:
causing, by the apparatus, the display to display data provided by another camera associated with another landing floor in response to a subsequent elevator call to the another landing floor.

14. The method of claim 13, wherein the subsequent elevator call is a car call.

15. The method of claim 10, wherein the elevator communication network comprises a point-to-point ethernet network.

16. The method of claim 10, wherein the elevator communication network comprises at least one multi-drop ethernet segment.

17. The method of claim 10, wherein the display (116A) is arranged in a car operating panel.

18. The method of claim 17, wherein the car operating panel comprises a call revocation button configured to cause the elevator car to stop to the nearest possible floor in response to an action of the call revocation button.

19. An apparatus, comprising:
means for receiving an elevator call to a landing floor; and
means for controlling a display arranged at an elevator car allocated to serve the elevator call to display data provided by a camera associated with the landing floor, the apparatus, the display and the camera being communicatively connected to an elevator communication network.

20. The apparatus of claim 19, wherein the apparatus comprises an elevator controller.

21. The apparatus of claim 19, wherein the apparatus comprises a server communicatively connected to the elevator communication network.

22. An elevator system comprising the elevator communication system of claim 1.

23. (canceled)

24. A non-transitory computer readable medium comprising program code, which when executed by at least one processor, causes the at least one processor to perform the method of claim 10.
